(19) United States
(12) Patent Application Publication
(10) Pub. No.: US 2015/0159807 A1
(43) Pub. Date: Jun. 11, 2015

(54) TANK

(71) Applicant: LNGTAINER AB, Helsingfors (FI)

(72) Inventor: Tom Sommardal, Helsingfors (FI)

(73) Assignee: LNGTAINER AB, Helsingfors (FI)

(21) Appl. No.: 14/412,677

(22) PCT Filed: Jun. 13, 2013
(86) PCT No.: PCT/FI2013/000027

§ 371 Date: Jan. 4, 2015

(30) Foreign Application Priority Data
Jul. 3, 2012 (FI) 20125769

(51) Int. Cl. F17C 1/12; F17C 1/16; F17C 1/00

(52) U.S. Cl. CPC F17C 1/12; F17C 1/005; F17C 1/16; F17C 2203/0354

(57) ABSTRACT

This invention relate to a tank, for transport and/or storage of cryogenic gases where the tanks insulation (1) are on the inside of the tank. The tanks insulation (1) has a leak proof layer (2) made of carbon fiber, fiberglass, plastic, metal or similar leak proof material.

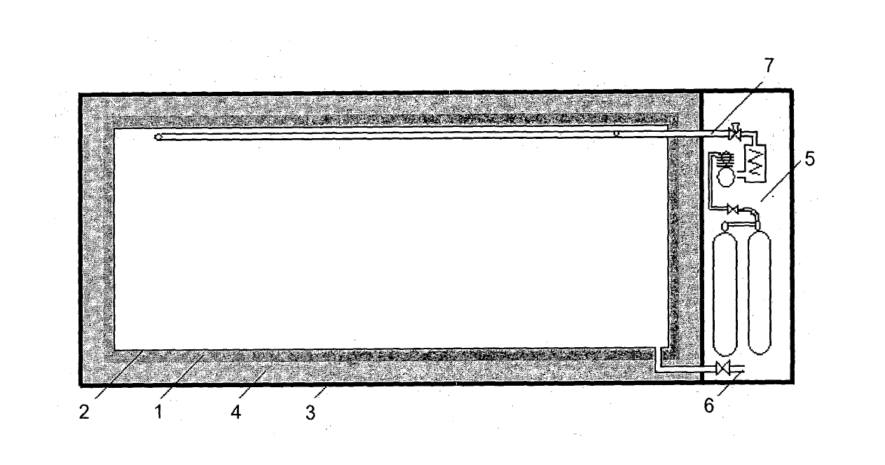

This invention is a tank intended to be used for transport as well as for storage of cryogenic gases where the tanks insulation is on the inside of the tank. The insulation have a leak proof layer made of carbon fiber, fiberglass, plastic, metal or similar leak proof material.

Earlier known systems are:
a) Vacuum insulated double walled tanks made of cold resistant metals.
b) Moss-Rosenberg type spherical tanks made of cold resistant metals with the insulation on the outside.
c) Membrane tanks

All the now known types of tanks for cryogenic gases are expensive because of expensive materials as well as complicated solutions:
a) Vacuum insulated double walled tanks are often pressure vessels which requires a more complicated manufacturing process. This method suits better for smaller tanks.
b) Moss-Rosenberg tanks are spherical an require therefore big space and volume.
c) Membrane tanks construction is frail because the membrane tank is made of a thin metal which does not sustain heavy loads which could occur when the tank is empty as well as when the tank will be burdened by heavy vibrations or impacts.

The characteristics for this innovation are:

That in connection to the tank is an engine room (5) which have space for collecting the “Boil-off” gas.

This inventions benefits are:
By collecting the “Boil-off gas” with high-pressure compressors which compresses the gas in to high-pressure vessels which are placed in the ends of the containers ends (engine room 5) will we get a natural friendly concept which does not release any gas to the atmosphere.
cost effective tank system with a low cost insulation
the gastight tank can be manufactured of normal steel
the tank can be box shaped or any shape.
the inner wooden tank is a part of the insulation
a strong layer fastened to the wooden tank.
the wooden insulation will take the forces which could occur during the transport when the liquid inside the tank is moving back and forth.

The invention is more detailed explained in the enclosed drawing where an example of the tank's cross section is shown.

The tank is intended for transport and/or storage of cryogenic gases, and its insulation 1 is placed inside the tank. The insulation 1 has an inner leak proof layer 2 of carbon fiber, fiberglass, plastic, metal or similar material as the leak proof layer against the liquefied gas. The insulation 1 is of wood, e.g. thermal treated wood which have a high insulation coefficient and a small temperature expansion coefficient. Between the insulation 1 and the tanks outer skin 3 is another insulation layer 4 made of cell plastic or corresponding insulation material. The tanks outer skin 3 is a gastight steel tank. In connection to the tank is an engine room 5 with vessels for collecting the “Boil-off” gas. The reference number 6 is the Inlet/Outlet for the cryogenic liquid and number 7 is the collecting pipe for the “Boil-off” gas.

The use of this type of tanks will be more cost efficient when they will be in standardized ISO container sizes.

By collecting the “Boil-of gas” with high-pressure compressors which compress the gas in to high-pressure vessels which are placed at the container's ends (engine room 5) will a natural friendly system which does not release any gas to the atmosphere. In addition could gas driven vehicles be fuelled direct from the container by e.g. 250 bar compressed gas. The tank can be used for the most of the cryogenic gases.

The innovation can be used for different sized tanks from ISO standard container sized up to big shore terminals as well as for gas tankers. In addition could the insulation materials thickness vary depending on the need and it could be done more effective with vacuum insulation.

1. Tank, for transport and/or storage of cryogenic gases where the tanks insulation (1) are on the inside of the tank and the tanks insulation (1) has a leak proof layer (2) made of carbon fiber, fiberglass, plastic, metal or similar leak proof material characterized that in connection to the tank is an engine room (5) with vessels for collecting the “Boil-off” gas.
